(19) United States
(12) Patent Application Publication
(10) Pub. No.: US 2025/0184021 A1
(43) Pub. Date: Jun. 5, 2025

(54) MOBILITY ENHANCEMENT FOR USER EQUIPMENT CONNECTED TO NON-TERRESTRIAL NETWORKS

(71) Applicant: QUALCOMM Incorporated, San Diego, CA (US)

(72) Inventors: Mohamad SAYED HASSAN, Paris (FR); Mohammed Ali Mohammed HIRZALLAH, San Marcos, CA (US)

(21) Appl. No.: 18/525,042

(22) Filed: Nov. 30, 2023

(51) Int. Cl. H04B 17/391; H04W 16/18

(52) U.S. Cl. CPC H04B 17/3913; H04W 16/18

(57) ABSTRACT

Methods, systems, and devices for wireless communications are described. A user equipment (UE) may receive a message that indicates terrestrial network (TN) mapping information that is associated with an artificial intelligence (AI) and/or machine learning (ML) model. The AI/ML model may be used to estimate a signal quality map and coverage information for a set of network entities, each associated with a respective TN. The UE may establish a communication link with a first network entity that is associated with a non-terrestrial network (NTN). The UE may search, while connected to the first network entity, for one or more TN cells that are associated with at least a subset of network entities of the set of network entities. The searching may be based on the UE estimating the signal quality map and the coverage information via the AI/ML model associated with the TN mapping information.

### FIELD OF TECHNOLOGY

The following relates to wireless communications, including mobility enhancement for user equipment (UEs) connected to non-terrestrial networks (NTNs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support mobility enhancement for user equipment (UEs) connected to non-terrestrial networks (NTNs). For example, the described techniques provide for a UE receiving a message that indicates terrestrial network (TN) mapping information. The TN mapping information may be associated with a machine learning (ML) and/or artificial intelligence (AI) model and/or function that is used to estimate a signal quality map and coverage information for a set of network entities. Each network entity of the set of network entities may be associated with a respective TN. The UE may establish a communication link between the UE and a first network entity that is associated with an NTN. In some aspects, the UE may search, while connected to the first network entity, for one or more TN cells that are associated with at least a subset of network entities of the set of network entities, and the searching may be based on the UE estimating the signal quality map and the coverage information via the AI/ML model and/or function that is associated with the TN mapping information.

A method for wireless communications by a UE is described. The method may include receiving a message indicating TN mapping information, the TN mapping information associated with a ML model for estimating a signal quality map and coverage information for a set of multiple network entities, where each network entity of the set of multiple network entities is associated with a respective TN, establishing a communication link between the UE and a first network entity that is associated with a NTN, and searching, while connected to the first network entity, for one or more TN cells associated with at least a subset of network entities of the set of multiple network entities, where the searching is based on the signal quality map and the coverage information estimated via the ML model.

A UE for wireless communications is described. The UE may include one or more memories storing processor executable code, and one or more processors coupled with the one or more memories. The one or more processors may individually or collectively operable to execute the code to cause the UE to receive a message indicating TN mapping information, the TN mapping information associated with a ML model for estimating a signal quality map and coverage information for a set of multiple network entities, where each network entity of the set of multiple network entities is associated with a respective TN, establish a communication link between the UE and a first network entity that is associated with a NTN, and search, while connected to the first network entity, for one or more TN cells associated with at least a subset of network entities of the set of multiple network entities, where the searching is based on the signal quality map and the coverage information estimated via the ML model.

Another UE for wireless communications is described. The UE may include means for receiving a message indicating TN mapping information, the TN mapping information associated with a ML model for estimating a signal quality map and coverage information for a set of multiple network entities, where each network entity of the set of multiple network entities is associated with a respective TN, means for establishing a communication link between the UE and a first network entity that is associated with a NTN, and means for searching, while connected to the first network entity, for one or more TN cells associated with at least a subset of network entities of the set of multiple network entities, where the searching is based on the signal quality map and the coverage information estimated via the ML model.

A non-transitory computer-readable medium storing code for wireless communications is described. The code may include instructions executable by one or more processors to receive a message indicating TN mapping information, the TN mapping information associated with a ML model for estimating a signal quality map and coverage information for a set of multiple network entities, where each network entity of the set of multiple network entities is associated with a respective TN, establish a communication link between the UE and a first network entity that is associated with a NTN, and search, while connected to the first network entity, for one or more TN cells associated with at least a subset of network entities of the set of multiple network entities, where the searching is based on the signal quality map and the coverage information estimated via the ML model.

In some examples of the method, UEs, and non-transitory computer-readable medium described herein, receiving the message indicating the TN mapping information may include operations, features, means, or instructions for receiving the message indicating the ML model that may be associated with the TN mapping information, the ML model being trained for generating the signal quality map and the coverage information for the one or more TN cells, where searching for the one or more TN cells may be based on one or more outputs of the ML model.

Some examples of the method, UEs, and non-transitory computer-readable medium described herein may further include operations, features, means, or instructions for training the ML model using a set of training data at the UE, where the searching may be based on one or more outputs of the ML model and in accordance with training the ML model.

Some examples of the method, UEs, and non-transitory computer-readable medium described herein may further include operations, features, means, or instructions for transmitting, to a network entity, a second message indicating the ML model for generating the signal quality map and the coverage information for the one or more TN cells.

Some examples of the method, UEs, and non-transitory computer-readable medium described herein may further include operations, features, means, or instructions for transmitting a capability message indicating that the UE may be capable of transmitting the ML model, where transmitting the second message indicating the ML model in accordance with the capability message.

Some examples of the method, UEs, and non-transitory computer-readable medium described herein may further include operations, features, means, or instructions for transmitting, to a network entity, a second message indicating, per component carrier, one or more signal quality maps for the one or more TN cells, where the one or more signal quality maps may be based on the ML model.

Some examples of the method, UEs, and non-transitory computer-readable medium described herein may further include operations, features, means, or instructions for transmitting a capability message indicating that the UE may be capable of receiving the TN mapping information, where receiving the message indicating the TN mapping information may be in accordance with the capability message.

Some examples of the method, UEs, and non-transitory computer-readable medium described herein may further include operations, features, means, or instructions for receiving a first set of reference signals from the set of multiple network entities associated with respective TNs and performing one or more signal quality measurements on a subset of reference signals from the first set of reference signals, where searching for the one or more TN cells may be based on the one or more signal quality measurements including an input to the ML model.

In some examples of the method, UEs, and non-transitory computer-readable medium described herein, receiving the message indicating the TN mapping information may include operations, features, means, or instructions for receiving the message indicating, for respective component carriers, one or more signal quality maps, where the ML model associated with the TN mapping information may be associated with the one or more signal quality maps.

Some examples of the method, UEs, and non-transitory computer-readable medium described herein may further include operations, features, means, or instructions for receiving, from a network entity of the set of multiple network entities that may be associated with a respective TN, a request message indicating a request to apply an offset to a first component carrier for estimating coverage information for a second carrier component different from the first component carrier.

Some examples of the method, UEs, and non-transitory computer-readable medium described herein may further include operations, features, means, or instructions for obtaining, via the ML model, a cell search decision for each TN cell associated with each network entity of the set of multiple network entities, where searching for the one or more TN cells may be based on the cell search decision.

In some examples of the method, UEs, and non-transitory computer-readable medium described herein, the cell search decision includes a binary indication of whether to search for a respective TN cell.

Some examples of the method, UEs, and non-transitory computer-readable medium described herein may further include operations, features, means, or instructions for searching for the one or more TN cells may be based on the cell search decision satisfying a threshold search parameter.

In some examples of the method, UEs, and non-transitory computer-readable medium described herein, the message indicating the TN mapping information may be received from the first network entity or a second network entity from the set of multiple network entities that may be associated with a respective TN.

In some examples of the method, UEs, and non-transitory computer-readable medium described herein, the coverage information for the set of multiple network entities includes coverage information for at least one network entity that may be based on a network energy savings mode of the at least one network entity, a TN configuration of the at least one network entity, or any combination thereof.

In some examples of the method, UEs, and non-transitory computer-readable medium described herein, the TN mapping information includes one or more inputs for the ML model, the one or more inputs including positioning information of the set of multiple network entities, an indication of a configuration of each respective TN, an indication of a configuration of the NTN, or any combination thereof.

In some examples of the method, UEs, and non-transitory computer-readable medium described herein, the configuration of each respective TN, the configuration of the NTN, or both, include a transmission power, an indication of an energy savings mode, or both.

In some examples of the method, UEs, and non-transitory computer-readable medium described herein, the ML model that may be received by the UE may be trained by a second UE.

In some examples of the method, UEs, and non-transitory computer-readable medium described herein, the signal quality map includes a reference signal received power (RSRP) map, a reference signal received quality (RSRQ) map, a signal interference noise ratio (SINR) map, or any combination thereof.

### BRIEF DESCRIPTION OF THE DRAWINGS

FIGS. 1 and 2 shows an example of a wireless communications system that supports mobility enhancement for user equipments (UEs) connected to non-terrestrial networks (NTNs) in accordance with one or more aspects of the present disclosure.

FIG. 3 shows an example of a block diagram of a machine learning (ML) model that supports mobility enhancement for UEs connected to NTNs in accordance with one or more aspects of the present disclosure.

FIG. 4 shows an example of a process flow that supports mobility enhancement for UEs connected to NTNs in accordance with one or more aspects of the present disclosure.

FIGS. 5 and 6 show block diagrams of devices that support mobility enhancement for UEs connected to NTNs in accordance with one or more aspects of the present disclosure.

FIG. 7 shows a block diagram of a communications manager that supports mobility enhancement for UEs connected to NTNs in accordance with one or more aspects of the present disclosure.

FIG. 8 shows a diagram of a system including a device that supports mobility enhancement for UEs connected to NTNs in accordance with one or more aspects of the present disclosure.

FIG. 9 shows a flowchart illustrating methods that support mobility enhancement for UEs connected to NTNs in accordance with one or more aspects of the present disclosure.

### DETAILED DESCRIPTION

In some wireless communication systems, user equipments (UEs) may be connected to network entities of non-terrestrial networks (NTNs) (e.g., satellites) that support relatively large cells and coverage areas. In some examples, an NTN UE may have to connect with a network entity of a terrestrial network (TN). For example, the UE may remain connected to the network entity of the NTN and perform frequency searches for different TNs. In some cases, such frequency searches may be relatively time consuming and computationally expensive. As such, a network entity may transmit information about geographical TN coverage areas to UEs. For example, the information may include location coordinates of the TN coverage area, boundary lines in the format of a list of coordinates, a list of locations and a shape for connecting a list of coordinate points, or any combination thereof. However, such information may result in a relatively high signaling overhead. Further, the information may be inaccurate and inefficient as the geographical information may assume a standard geometric shape for the coverage area of a TN, even though the shape of the coverage area may be relatively irregular.

In accordance with the techniques of the present disclosure, a network entity may transmit TN mapping information to an NTN connected UE to reduce the signaling overhead and provide relatively more accurate information about one or more TN coverage areas. For example, the UE may receive information about TNs to perform inferences or estimations for a TN signal quality map. That is, a network entity may transmit an artificial intelligence (AI) or machine learning (ML) model and/or function to the UE for determining TN coverage and signal quality of non-measured cells and cell search decisions. The UE may measure a subset of received reference signals from a subset of TN cells to receive corresponding signal quality measurements which the UE inputs, along with other information, into the AI/ML model. The AI/ML model may then determine, predict, or estimate the signal quality measurements of one or more non-measured TN cells. Additionally, or alternatively, the AI/ML model may output a probability of TN coverage for the non-measured TN cells, a cell search decision for whether the UE should search for the non-measured cells, or both. By using the AI/ML model, the UE may determine information associated with respective TNs (e.g., TN cells) in a relatively more accurate and efficient manner, while also reducing the signaling overhead between the network and the UE.

Aspects of the disclosure are initially described in the context of wireless communications systems. Additional aspects of the disclosure are described herein with reference to wireless communications systems, an AI/ML model block diagram, and a process flow. Aspects of the disclosure are further illustrated by and described with reference to apparatus diagrams, system diagrams, and flowcharts that relate to mobility enhancement for UEs connected to NTNs.

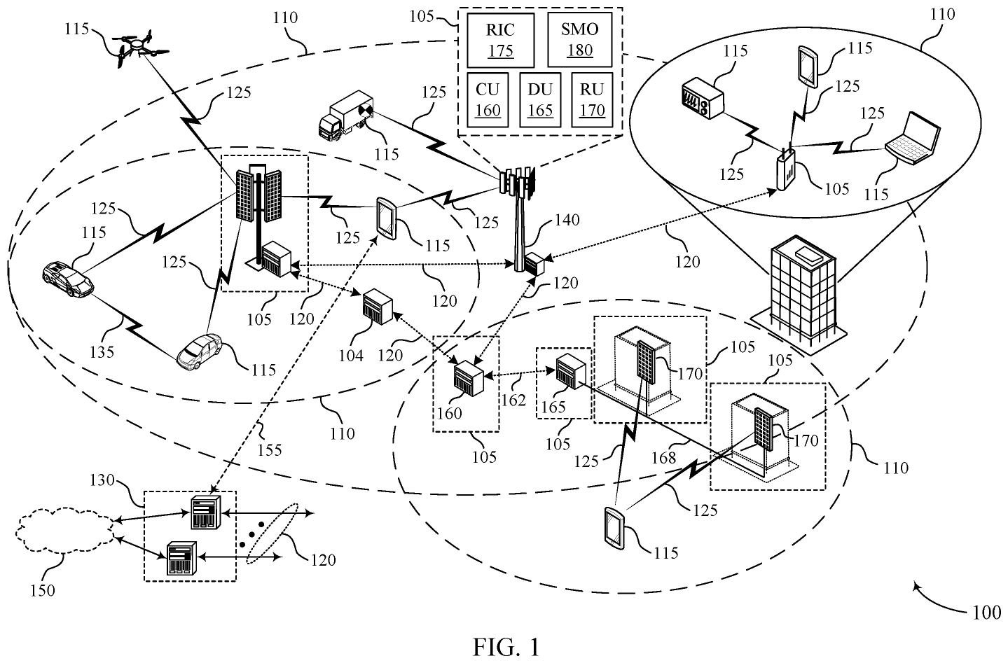

FIG. 1 shows an example of a wireless communications system 100 that supports mobility enhancement for UEs connected to NTNs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1. In some examples, a UE 115 may support AI and/or ML functionalities, which the UE 115 may use to perform one or more wireless communications procedures (e.g., CSI prediction, beam selection or beam prediction, among other examples). For example, the UE 115 may generate inference data associated with one or more AI/ML functions. Additionally, or alternatively, the UE 115 may perform life cycle management (LCM) operations for a given AI/ML model and/or functionality (e.g., model or functionality selection, activation, deactivation, switching, and fallback, among other examples). As described herein, an AI functionality or AI model may be referred to as an ML functionality or ML model, or vice versa. That is, the terms “AI” and “ML” may, in some examples, be used interchangeably to refer to similar technologies, models, functions, or any combination thereof. In some examples, ML operations may be considered a subset of AI operations. In any case, aspects of the features described herein may be referred to as ML functionalities, ML functions, ML models, ML services, ML operations, or the like, but these aspects may be similarly applicable to AI functionalities, AI functions, AI models, AI services, AI operations, or any combination thereof. Thus, reference to “ML” herein may refer to ML, AI, or both, and the term “ML” should not be considered limiting to the scope of the claims or the disclosure.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support mobility enhancement for UEs connected to NTNs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, UEs 115, network entities 105, or both may use AI and ML models. For example, a UE 115, a network entity 105, or both may implement beam management procedures using AI/ML models. In a first beam management case, downlink beam prediction for a first set of beams (e.g., set A) may be based on measurement results of a second set of beams (e.g., set B) using an AI/ML model that is trained and used by the network entity 105, the UE 115, or any combination thereof. In some cases, set A and set B may be different (e.g., set B may include different beams from the beams in set A) or set B may be a subset of set A. Moreover, the beams of set A may be for downlink beam predictions and the beams of set B may be for downlink beam measurements where the codebook construction for the beams in set A and set B may be constructed by manufacturers prior to deployment. In addition, the AI/ML model may include one or more inputs. The one or more inputs may include level 1 (L1) reference signal received power (L1-RSRP) measurements based on set B, L1-RSRP measurements based on set B and assistance information, channel impulse responses (CIRs) based on set B, L1-RSRP measurements based on set B and the corresponding downlink transmission/reception beam identifiers (IDs), or any combination thereof.

In a second beam management case, an AI/ML model may be used for temporal downlink beam predictions for the beams of set A based on the historic measurement results of the beam of set B. Such AI/ML model may further be trained or used for inference at a network entity 105, a UE 115, or any combination thereof. Further, the beams of set A and set B may be different, the beams of set B may be a subset of the beams of set A, or the beams of set A and set B may be the same. In addition, the AI/ML model may use one or more inputs such as measurement results of the K (e.g., K≥1) latest measurement instances. Such measurements may be L1-RSRP measurements based on the beams of set B, L1-RSRP measurements based on the beams of set B and assistance information, L1-RSRP measurements based on the beams of set B and the corresponding downlink transmission/reception beam IDs, or any combination thereof. Additionally, or alternatively, the outputs of the AI/ML model may include F (e.g., where F at least equals 1) predictions for F future time instances (e.g., slots, frames, TTIs) where each prediction is for each time instance. Further, AI/ML models may be used for mobility scenarios and for radio resource management (RRM).

In some examples of the wireless communications system 100, UEs 115 may be connected to one or more network entities 105 of NTNs (e.g., satellites) that support relatively large cells and coverage areas 110. In some cases, the coverage area 110 of an NTN cell may also cover areas without TN coverage. As such, NTN frequencies may have a relatively higher priority for cell reselection as NTN cells may cover relatively larger areas. However, in some examples, a UE 115 may have to connect with a TN network entity 105 and perform frequency searches for different TNs, for example, while connected with the NTN, which may be relatively time consuming and computationally expensive for a UE 115. For example, UEs may perform unnecessary frequency searches for different TNs or RATs. As such, in some examples, a network entity 105 may transmit information about geographical TN coverage areas to UEs 115. In some other examples, TN frequencies may be deployed such that the frequencies are specific to a region and a UE 115 may search from a single list of frequencies. In another example, the UE may receive TN cell zone information indicating where TN cell coverage may be unavailable.

Further, to save signaling overhead and to reduce power consumption, a UE 115 may refrain from performing neighboring cell measurements for TN neighbor cells in areas where there may be a lack of or relatively limited TN coverage. To enable such capabilities, UEs 115 supported by an NTN (e.g., a network entity 105 of an NTN) may receive broadcast signaling that indicates information about the TN coverage areas that is associated with corresponding frequency information. In some cases. the information about TN coverage areas may include geographical information of a respective TN coverage area such as location coordinates of a coverage area and a radius of the respective TN coverage area. In some other cases, the TN coverage area information may include boundary lines in the format of a list of coordinates. A UE 115 may also receive an indication of which side of a respective boundary line is the TN coverage area. In another case, the TN coverage area may include a list of locations and a shape (e.g., a polygon) for connecting a list of coordinate points to illustrate a respective TN coverage area.

However, such information may result in a relatively high signaling overhead as the list of location coordinates may be relatively large. Further, the shaping of the coordinates may be inefficient, as the geographical information may assume a standard geometric shape (e.g., circular, hexagonal) for the coverage area of a TN, even though the shape of the coverage area may be based on radio signal levels and thus relatively irregular. Moreover, to accurately represent the coverage area of a TN, the UE may expect information associated with an RSRP map. Additionally, or alternatively, the geographical location information may be deterministic and may refrain from considering one or more factors. For example, the geographical information may refrain from considering upgrades to a TN (e.g., adding additional component carrier (CC) operators), abnormal TN coverage or issues with TN coverage related to sub-optimal network configurations (e.g., overshooting cells, TN network entity 105 power settings), dynamic power saving modes for TNs, or any combination thereof.

The wireless communications system 100 may support techniques for reducing signaling overhead and providing accurate information about a TN coverage area for a UE 115 to search for TNs. The described techniques may reduce power consumption and complexity of searching for TN cells by enabling a UE 115 to avoid unnecessary frequency searches for different TNs. For example, after a UE 115 establishes a connection with a network entity 105 of an NTN, the UE 115 may receive information about TNs to perform inferences or estimations for a TN signal quality map. That is, a network entity 105 may transmit an AI/ML model to the UE 115 for determining TN coverage and signal quality of non-measured cells and cell search decisions. The UE 115 may measure a subset of received reference signals from a subset of TN cells. As such, the UE may input such reference signal measurements along with other information into the AI/ML model to determine (e.g., predict) the signal quality of one or more non-measured TN cells. Additionally, or alternatively, the AI/ML model may output a probability of TN coverage for the non-measured TN cells, a cell search decision for whether a UE 115 should search the non-measured, or both. As such, by using the AI/ML model, the UE may be capable of determining information associated with respective TNs in a more accurate and efficient manner while also reducing the signaling overhead between the network and the UE.

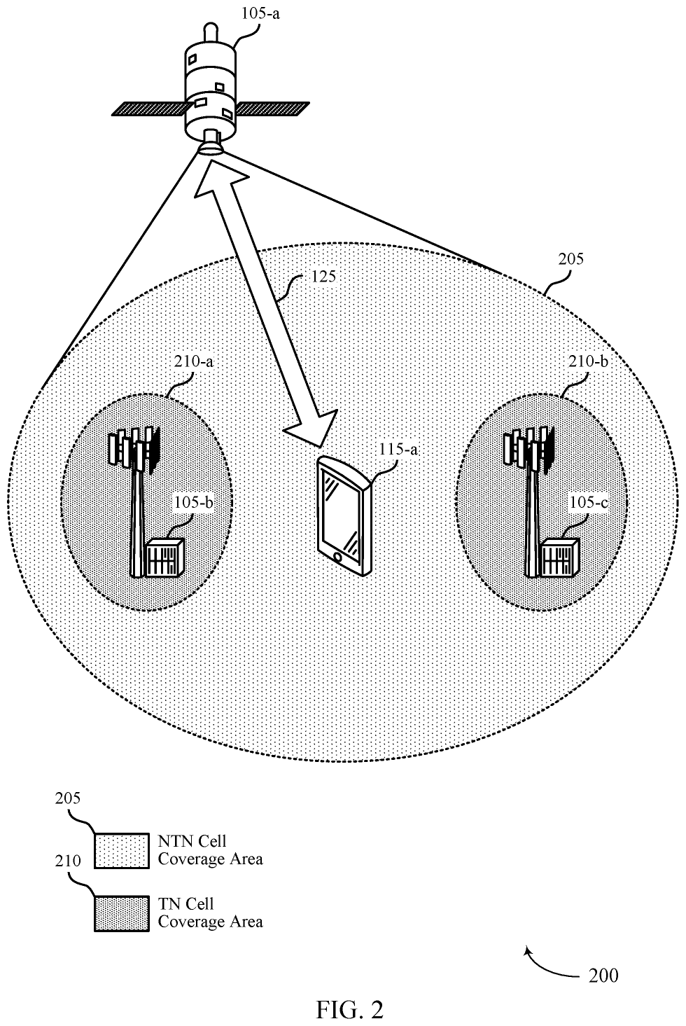

FIG. 2 shows an example of a wireless communications system 200 that supports mobility enhancement for UEs connected to NTNs in accordance with one or more aspects of the present disclosure. In some examples, the wireless communications system 200 may implement or be implemented by the wireless communications system 100. For example, the wireless communications system 200 may include a UE 115-a, a network entity 105-a that supports an NTN cell 205, a network entity 105-b that supports a TN cell 210-a, and a network entity 105-c that supports a TN cell 210-b, which may represent examples of corresponding devices described herein. The UE 115-a and the network entity 105-a may communicate via a communication link 125 which may be an example of a communication link 125 described with reference to FIG. 1. The communication link 125 may be examples of a Uu link, a sidelink, a backhaul link, a D2D link, or some other type of communication link 125 described herein with reference to FIG. 1.

In some examples, the UE 115-a may be within the coverage area of the NTN cell 205. As such, the UE 115-a may be supported (e.g., served) by the network entity 105-a that supports the NTN cell 205. To initiate the service and communications between the UE 115-a and the network entity 105-a, the UE 115-a may establish the communication link 125 with the network entity 105-a. In some examples, the communication link 125 may include an uplink communication link from the UE 115-a to the network entity 105-a and a downlink communication link from the network entity 105-a to the UE 115-a. Further, it should be understood that the communication link 125 illustrated herein may include an uplink communication link, a downlink communication link, or both. Moreover, in some cases, the network entity 105-a that supports the NTN cell 205 may be referred to as an NTN entity 105 or a satellite elsewhere herein. As such, the UE 115-a may communicate with the network entity 105-a via the communication link 125 and vice versa.

In some examples, while connected to the network entity 105-a, the UE 115-a may search for one or more TN cells 210 to connect with. For example, the UE 115-a may have to connect to a network entity 105 of a respective TN cell that is at least partially within the coverage area of the NTN cell. For example, due to the relatively fast movement of the network entity 105-a (e.g., the satellite) compared to the movement of the UE 115-a, the UE 115-a may connect with a network entity 105 associated with a TN to enhance coverage and the reliability of communications within the wireless communications system 200. As such, the UE 115-a may perform one or more frequency searches for TNs or RATs. In some cases, such frequency searches may be inefficient, time consuming, and computationally expensive for the UE 115-a. As such, to avoid unnecessary frequency searches, the UE 115-a may receive a message from a network entity 105 (e.g., the network entity 105-a, the network entity 105-b, or the network entity 105-c) indicating the coverage area information for a respective TN cell 210 (e.g., the TN cell 210-a or the TN cell 210-b).

In some cases, as described with reference to FIG. 1, the coverage area information for a respective TN cell 210 may include geographical information associated with the respective TN cell 210. Such geographical information may include location coordinates that outline the coverage are of a respective TN cell 210 or the boundary of a respective TN cell 210. In some cases, the location coordinates may be in the form of geographical coordinate system (GCS) coordinates (e.g., latitude and longitude coordinates), universal transverse Mercator (UTM) coordinates, or in the form of any other type of coordinate system. The UE 115-a may use a global positioning system (GPS) (e.g., a GPS sensor, component, or service at the UE 115-a) to determine where the respective TN cell 210 coverage area is with respect to the position of the UE 115-a. For example, in some cases, the UE 115-a may move relatively frequency and in some examples at relatively high speeds (e.g., when the UE 115-a is an example of some type of vehicle). As such, the UE 115-a may calculate how far away from a respective TN cell 210 that the UE 115-a is at any given time since the respective TN cells 210 may be relatively static.

In some cases, however, a TN cell 210 coverage area may change due to a change associated with (e.g., an upgrade of) a TN supported by a network entity 105 (e.g., the network entity 105-b or the network entity 105-c). As such, the TN cell 210 geographical information may be relatively inaccurate as the coverage area may changes such that a boundary of a respective TN cell is closer to the UE 115-a. In some other cases, a network entity 105 may experience one or more issues that may impact the coverage area of a respective TN cell 210, or a network entity 105 may implement power savings modes (e.g., a network energy saving (NES) mode) that may also impact the coverage area of a respective TN cell 210. Further, the network entity 105 that transmits the geographical information may assume a standard shape (e.g., a circle, a rectangle, a square, a hexagon) for a respective TN cell 210 even though the shape of a respective TN cell 210 may be relatively irregular. Thus, the geographical information may be inefficient, inaccurate, or both, in aiding the UE 115-a in searching for TN cells 210. Moreover, the message to indicate the coverage area information for a respective TN cell 210 may be associated with a relatively high signaling overhead resulting in further reduction in the efficiency and reliability of the wireless communications system 200.

The techniques of the present disclosure may enable the UE 115-a to efficiently, accurately, and reliably search for respective TN cells 210. For example, the UE 115-a may receive a message from a network entity 105 (e.g., the network entity 105-a, the network entity 105-b, or the network entity 105-c) indicating TN mapping information. In some cases, the TN mapping information may include a radio coverage map (e.g., an RSRP map) of a respective TN cell 210 to the UE 115-a that is supported by the network entity 105-a (e.g., an NTN entity 105). In some examples, the TN mapping information may also be associated with an ML model for estimating a signal quality map and coverage information for a set of network entities 105. Further, each network entity 105 of the set of network entities (e.g., the network entity 105-b and the network entity 105-c) may be associated with a respective TN cell 210 (e.g., the TN cell 210-a or the TN cell 210-b). In some cases, the ML model may be used to convey (e.g., express, represent, or illustrate) a compressed model for a RSRP map and/or a geographical TN coverage map. That is, the UE 115-a may use the ML model to estimate a signal quality map (e.g., an RSRP map) and coverage information (e.g., a geographical TN coverage map) for a respective TN cell 210. The ML model described herein may referred to as an AI model or an AI/ML model elsewhere herein.

In some examples, a network entity 105 may know (e.g., identify) the TN coverage information and signal quality information (e.g., RSRPs) for a respective TN cell 210. As such, an ML model (e.g., the AI/ML model) may be trained to learn and/or memorize the TN coverage information and signal quality information for a respective TN cell 210. Further, in some cases, a network entity 105 (e.g., the network entity 105-a, the network entity 105-b, the network entity 105-c) may train the ML model and exchange the ML model with the UE 115-a. The UE 115-a may use the trained ML model to estimate the signal quality map and coverage information of a respective TN cell 210 (e.g., the TN cell 210-a or the TN cell 210-b). The network entity 105 may transmit the TN mapping information per CC to the UE 115-a that is within the coverage area of the NTN cell 205 supported by the network entity 105-a. That is, the UE 115-a may receive one or more messages indicating respective TN mapping information for a respective CC. Additionally, or alternatively, the UE 115-a may receive the message that indicates the TN mapping information and receive an indication of one or more signal quality maps (e.g., radio signal or RSRP maps), where the ML model that is associated with the TN mapping information may also be associated with the one or more signal quality maps. In some examples, the signal quality maps received per CC may be RSRP maps, reference signal received quality (RSRQ) maps, signal interference noise ratio (SINR) maps, or any combination thereof.

In some examples, a network entity 105 may transmit the message via a broadcast within a system information block (SIB). For example, the SIB may indicate information on how the UE 115-a may download or obtain the ML model or an index of the ML model. In such examples, the network entity may transmit the information via a broadcast such that a relatively large quantity of UEs 115 may receive the TN mapping information for a respective CC. For example, the network entity 105-a may broadcast the information to each UE 115 (e.g., including the UE 115-a) within the NTN cell 205 that is supported by the network entity 105-a. In another example, the network entity 105-b or the network entity 105-c may broadcast the information such that each UE 115 that may be covered by the respective network entity 105, is capable of receiving the associated TN mapping information, or both. Additionally, or alternatively, the UE 115-a may receive the TN mapping information via the application layer. For example, while the UE 115-a is within a TN cell 210 (e.g., the TN cell 210-a supported by the network entity 105-b or the TN cell 210-b supported by the network entity 105-c), the UE 115-a may download the TN mapping information to reuse at a later time period. In another example, the UE 115-a may receive the TN mapping information from the network entity 105-a via the application layer while the UE 115-a is within the NTN cell 205.

As such, using the techniques of the present disclosure, a network entity 105 may use a relatively smaller signaling overhead to transmit the TN mapping information to the UE 115-a compared to transmitting the geographical coverage area information for a TN cell 210 as described herein. Further, enabling the UE 115-a to receive and execute the ML model associated with the TN mapping information may allow the UE 115-a to perform relatively fewer computations compared to searching for TN cells 210. In addition, the UE 115-a may be capable of updating and reconfiguring the ML model to consider TN upgrades and changes to a TN configuration (e.g., changing a power mode, change in the tilt of an antenna). In some cases, the TN coverage information and associated RSRPs of a respective TN cell may be unknown or partially known by a network entity 105. As such, a network entity 105 may use the ML model to learn the unknown information before the network entity 105 exchanges the ML model with the UE 115-a. In some cases, instead of signaling the ML model to the UE 115-a, a network entity 105 (e.g., the network entity 105-a, the network entity 105-b, or the network entity 105-c) may run or execute the ML model to learn (e.g., estimate or infer) the signal quality map and coverage information for a respective TN cell 210 and transmit the ML model results to the UE 115-a. For example, the UE 115-a may transmit a capability message to indicate whether the UE 115-a is capable of receiving a signal quality map (e.g., a signal quality map generated via an ML model) or receiving an ML model for a CC. As such, in some cases, the UE 115-a may be incapable of receiving the ML model and the network entity 105 that trains the ML model may also run the ML model and transmit the results (e.g., the inference of the ML model) of the ML model to the UE 115-a.

In another example, the TN coverage information and the RSRPs of a respective TN cell 210 may be unknown and may be learned by the UE 115-a. In such examples, the UE 115-a may train the ML model to estimate the signal quality maps and coverage information of a respective TN cell 210. For example, in some cases, the UE 115-a may have a set of training data stored at the UE 115-a to train the ML model. In some other cases, the UE 115-a may identify the set of training data through crowdsourcing or through communications with respective TN cells 210. For example, the UE 115-a may use historical data measured or obtained at the UE 115-a or from other wireless devices (e.g., UEs 115 or network entities 105). Further, the UE 115-a may also share the ML model with a network entity 105 to be shared with other UEs 115. As such, the network entity 105-a may transmit the TN mapping information to the UE 115-a, the UE 115-a may train the ML model associated with the TN mapping information, and the UE 115-a may transmit the trained ML model back to the network entity 105-a. In some cases, the UE 115-a may transmit the ML model weights or hyperparameters used to train the ML model to the network entity 105-a. As such, the network entity 105-a may then transmit the trained ML model to other UEs 115 that the network entity 105-a supports or UEs 115 that enter the NTN cell 205 that the network entity 105-a supports.

As such, in some cases, a UE 115 may receive the TN mapping information from a network entity 105 that is associated with an ML model trained by a different UE 115. For example, the UE 115-a may transmit a capability message that indicates that the UE 115-a is capable of receiving an RSRP map (e.g., a compressed RSRP map) from a network entity 105 per CC, providing (e.g., transmitting) an RSRP map to a network entity 105 per CC, or both. Therefore, a network entity 105 may obtain (e.g., receive) the ML model, TN RSRP map (e.g., compressed RSRP map), or both, per CC from a first UE and then share the obtained the ML model, TN RSRP map, or both with a second UE.

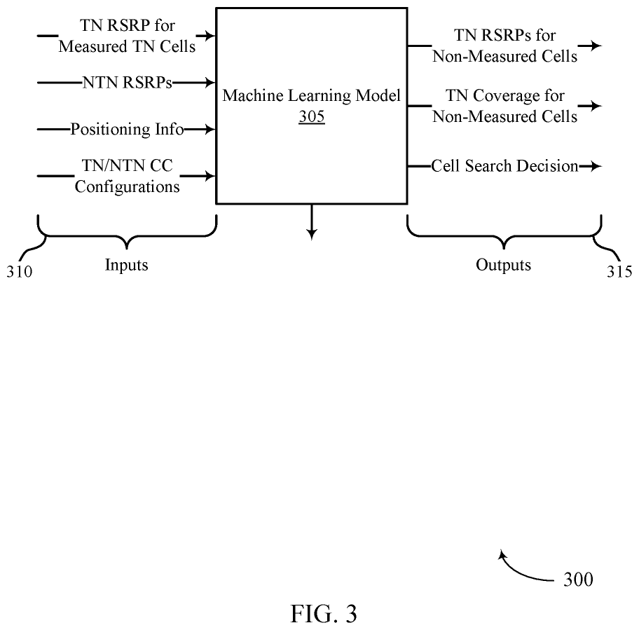

Using the ML model, a UE 115 (e.g., the UE 115-a) may be capable estimating a signal quality map and coverage information from a respective TN cell 210. The UE 115-a may also be capable of estimating a cell search decision to determine whether to search for one or more TN cells 210. As such, the UE 115-a may be capable of preventing unnecessary searches for TN cells 210 therefore proving a more efficient use of communication resources and reducing the power consumption, time, and complexity of searching for respective TN cells 210. Further descriptions of how the ML model may be implemented using one or more inputs, the one or more outputs of the ML model, and how the ML model may be trained may be described elsewhere herein with reference to FIG. 3.

FIG. 3 shows an example of a block diagram 300 of an ML model 305 that supports mobility enhancement for UEs connected to NTNs in accordance with one or more aspects of the present disclosure. In some examples, the block diagram 300 may implement or be implemented by the wireless communications system 100. Further, the ML model 305 may implement one or more inputs 310 to generate one or more outputs 315. In some cases, the ML model 305 may be referred to as an ML model, an AI model, an AI/ML model, or an inference model elsewhere herein.

In some examples, the ML model 305 may receive the one or more inputs 310 from network entities 105 and UEs 115 to generate the one or more outputs 315. For example, a first input 310 may include one or more TN RSRP measurements associated with respective CCs for a subset of measured TN cells. That is, a UE 115 may receive one or more reference signals from one or more network entities associated with respective TN cells to perform reference signal measurements (e.g., RSRP measurements). In some cases, a second input 310 for the ML model 305 may include one or more NTN RSRP measurements associated with respective CCs from the NTN entity 105 that the UE 115 is connected with. For example, the NTN entity 105 may transmit one or more reference signals to the UE 115 and the UE 115 may measure a subset of the reference signals to be used as an input 310 to the ML model 305. In some cases, a third input 310 for the ML model 305 may the positioning information of the wireless device running the ML model 305. For example, a UE 115 may use a GPS component or service to determine the position of the UE 115 and provide such information as an input to the ML model 305. In some other cases, a fourth input 310 for the ML model 305 may be the configurations of a TN or NTN (e.g., TN/NTN configurations) for a respective CC. In some examples, the TN/NTN configurations may include an indication of a transmission power mode, an indication of a NES mode, an indication of a transmission power level, or any combination thereof.

As such, a UE 115 may run the ML model 305 using the one or more inputs 310 to generate the one or more outputs 315. Further, it should be understood that the one or more inputs 310 described herein may each be optional and may be used in any combination to generate the one or more outputs 315 described herein. As such, the one or more inputs 310 may assist in the generation of the one or more outputs 315 of the ML model 305 that provide estimations or inferences about respective TN cells. For example, a first output 315 may be the estimated RSRPs of non-measured TN cells. That is, in some cases, the UE 115 may measure the RSRPs for a subset of TN cells which may be used as a first input 310 into the ML model 305 to aid in predicting the RSRP values for the non-measured TN cells. In another example, a second output 315 may be a probability of TN coverage for the non-measured TN cells.

Further, a third output 315 may include a cell search decision. For example, based on the one or more inputs 310, the ML model 305 may generate a cell search decision to determine whether a UE 115 should search a respective neighboring non-measured TN cell. In some cases, the cell search decision may be a hard decision (e.g., binary) that indicates one of two options (e.g., the UE 115 should search the non-measured TN cell, or the UE 115 should not measure the non-measured TN cell). In some other cases, the cell search decision may be a soft decision (e.g., dynamic or analog) that is based on a probability. For example, the cell search decision may indicate a probability of whether the search may be beneficial to the UE 115.

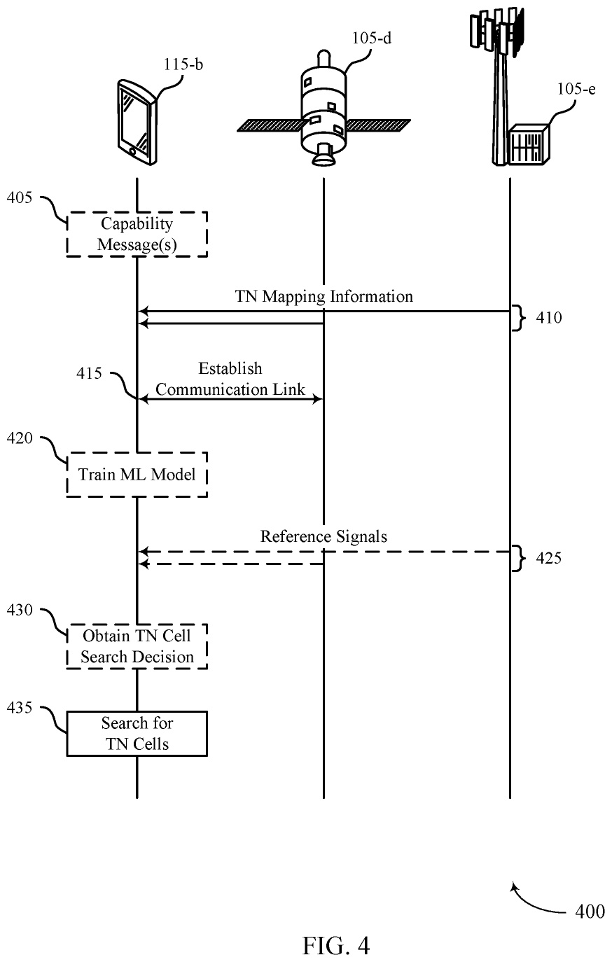

Moreover, as discussed herein with reference to FIG. 2, the UE 115 or a network entity 105 may train the ML model 305 (e.g., the UE 115 or a network entity 105 may apply the training to the ML model 305) to estimate the signal quality map and the coverage information for a respective TN cell. In some cases, the coverage information for a respective TN cell may include or consider the NES mode of a network entity 105 of the respective TN cell and the configuration of the TN. Further, in some examples, to enhance the capabilities of the ML model 305, a network entity 105 may send a message to the UE 115 to apply an offset to the coverage information for a respective TN cell for a first CC. As such, the UE 115 may be capable of deriving (e.g., estimating) the coverage information for the respective TN cell for a second CC that is different from the first CC. Further the ML model 305 may use the one or more inputs 310 to generate the one or more outputs 315 that aid a UE 115 in estimating a signal quality map and the coverage information for a set of network entities that are associated with respective TNs. Using the ML model 305 via the techniques of the present disclosure, a wireless communications system may be capable of reducing the signaling overhead used to signal TN coverage. Further descriptions of the techniques of the present disclosure may be described elsewhere herein, including with reference to FIG. 4.

FIG. 4 shows an example of a process flow 400 that supports mobility enhancement for UEs connected to NTNs in accordance with one or more aspects of the present disclosure. In some examples, the process flow 400 may implement or be implemented by the wireless communications system 100 and/or wireless communications system 200. For example, the process flow 400 may include a UE 115-b, a network entity 105-d, and a network entity 105-e, which may be examples of devices described herein with reference to FIG. 1.

In the following description of the process flow 400, the operations between the UE 115-b, the network entity 105-d, and the network entity 105-e may be performed in different orders or at different times. Some operations may also be left out of the process flow 400, or other operations may be added. Although the UE 115-b, the network entity 105-d, and the network entity 105-e are shown performing the operations of the process flow 400, some aspects of some operations may also be performed by one or more other wireless devices.

At 405, the UE 115-b may transmit a capability message indicating that the UE 115-b is capable of receiving TN mapping information. The UE 115-b may also transmit a capability message indicating that the UE 115-b is capable of transmitting an ML model.

At 410, the UE 115-b may receive, from the network entity 105-d or the network entity 105-e, a message indicating TN mapping information that is associated with an ML model. The UE 115-b may use the ML model to estimate a signal quality map and coverage information for a set of network entities 105 where each network entity 105 (e.g., the network entity 105-e) of the set of network entities is associated with a respective TN. In some cases, the UE 115-b may also receive the TN mapping information in accordance with the capability message that indicates that the UE 115-b is capable of receiving the TN mapping information. Further, in some examples, the signal quality map may include an RSRP map, an RSRQ map, an SINR map, or any combination thereof.

In some examples, when UE 115-b receives the message indicating the TN mapping information, the UE 115-b may also receive the ML model that is associated with the TN mapping information. In some cases, the ML model may be trained for generating the signal quality map and the coverage information for one or more TN cells. Further, the ML model may be trained by network entity 105-d or the network entity 105-e which may be within the set of network entities 105 that are associated with respective TNs. Additionally, or alternatively, the UE 115-b may receive an ML model that a second UE 115 has trained. In some other examples, the message may indicate one or more signal quality maps for respective CCs. As such, the ML model associated with the TN mapping information may be associated with the one or more signal quality maps.

Further, the coverage information for the set of network entities 105 may include coverage information for at least one network entity 105 (e.g., the network entity 105-c) that is based on an NES of the network entity 105-e, a TN configuration of the network entity 105-e, or any combination thereof. In some cases, the TN mapping information may also include one or more inputs for the ML model. The one or more inputs may include positioning information of the set of network entities 105, an indication of a configuration of each respective TN, an indication of a configuration of an NTN connected to the UE 115-b, or any combination thereof. Further, the configuration of each respective TN, the configuration of the NTN, or both may include a transmission power, an indication of an energy savings mode, or both. Additionally, or alternatively, the UE 115-b may receive, subsequent to the TN mapping information and from a network entity 105 of the set of network entities 105 (e.g., the network entity 105-c) that is associated with a respective TN, a request message indicating a request to apply an offset to a first CC for estimating coverage information for a second CC that is different from the first CC.

As such, at 415, the UE 115-b may establish a communication link with the network entity 105-d that is associated with an NTN. In some examples, the network entity 105-d may be referred to as an NTN entity 105 or a satellite elsewhere herein.

In some cases, at 420, the UE 115-b may train the ML model using a set of training data at the UE 115-b. For example, the UE 115-b may receive an untrained ML model at 410 and may then train the ML model at the UE 115-b. As such, after training the ML model, the UE 115-b may transmit, to a network entity 105 (e.g., the network entity 105-e), a second message indicating the ML model for generating the signal quality map and the coverage information for one or more TN cells. Further, in some cases, the UE 115-b may transmit, to a network entity 105, a message (e.g., a second message) indicating one or more signal quality maps for one or more TN cells per CC where the one or more signal quality maps may be based on the ML model. Additionally, or alternatively, the UE 115-b may transmit the ML model in accordance with the capability message that indicates that the UE 115-b is capable of transmitting the ML model.

At 425, the UE 115-b may receive a first set of reference signals from the set of network entities 105 (e.g., including the network entity 105-e) associated with respective TNs. In some cases, the UE 115-b may also receive a second set of reference signals from the network entity 105-d that is associated with an NTN. As such, the UE 115-b may perform one or more signal quality measurements (e.g., RSRP, RSRQ, or SINR measurements) on a subset of reference signals (e.g., from the first set of reference signals, the second set of reference signals, or both).

At 430, the UE 115-b may obtain, via the ML model, a cell search decision for each TN cell associated with each network entity 105 of the set of network entities 105. In some cases, the cell search decision may be a binary indication of whether to search for a respective TN cell.

Therefore, at 435, the UE 115-b may search, while connected to the network entity 105-d, for one or more TN cells associated with at least a subset of network entities 105 of the set of network entities 105. The searching may be based on the signal quality map and the coverage information estimated via the ML model. Further, in some cases, the searching for the one or more TN cells may be based on one or more outputs of the ML model. Additionally, or alternatively, the searching may be based on the one or more outputs of the ML model and in accordance with training the ML model at 420. In some other cases, searching for the one or more TN cells may be based on the one or more signal quality measurements from the subset of reference signals measured at 425, where the one or more signal quality measurements are used as an input to the ML model. In another example, the searching for the one or more TN cells may be based on the cell search decision obtained at 430. Further, the searching may be based on the obtained cell search decision satisfying a threshold search parameter.

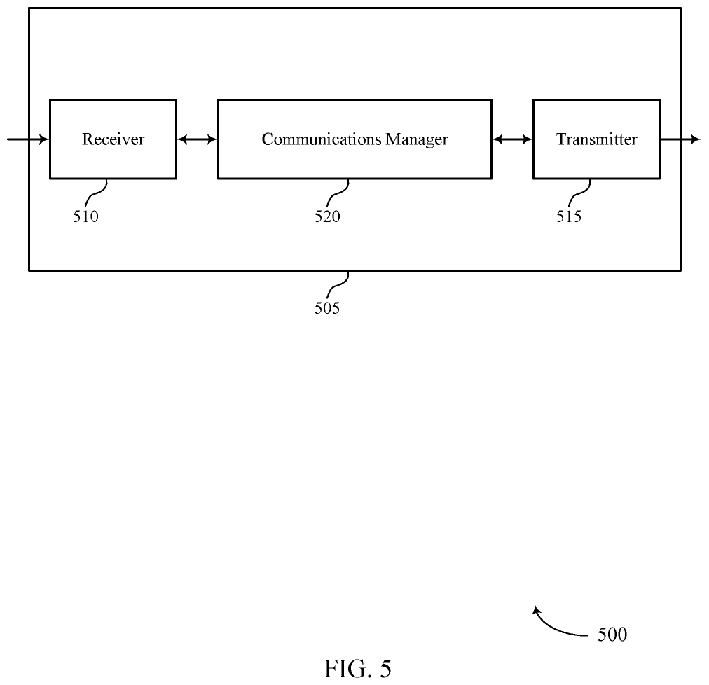

FIG. 5 shows a block diagram 500 of a device 505 that supports mobility enhancement for UEs connected to NTNs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to mobility enhancement for UEs connected to NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mobility enhancement for UEs connected to NTNs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of mobility enhancement for UEs connected to NTNs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a message indicating TN mapping information, the TN mapping information associated with an ML model for estimating a signal quality map and coverage information for a set of multiple network entities, where each network entity of the set of multiple network entities is associated with a respective TN. The communications manager 520 is capable of, configured to, or operable to support a means for establishing a communication link between the UE and a first network entity that is associated with an NTN. The communications manager 520 is capable of, configured to, or operable to support a means for searching, while connected to the first network entity, for one or more TN cells associated with at least a subset of network entities of the set of multiple network entities, where the searching is based on the signal quality map and the coverage information estimated via the ML model.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a UE to more accurately receive or determine TN coverage information to support reduced processing, reduced power consumption, and more efficient utilization of communication resources.

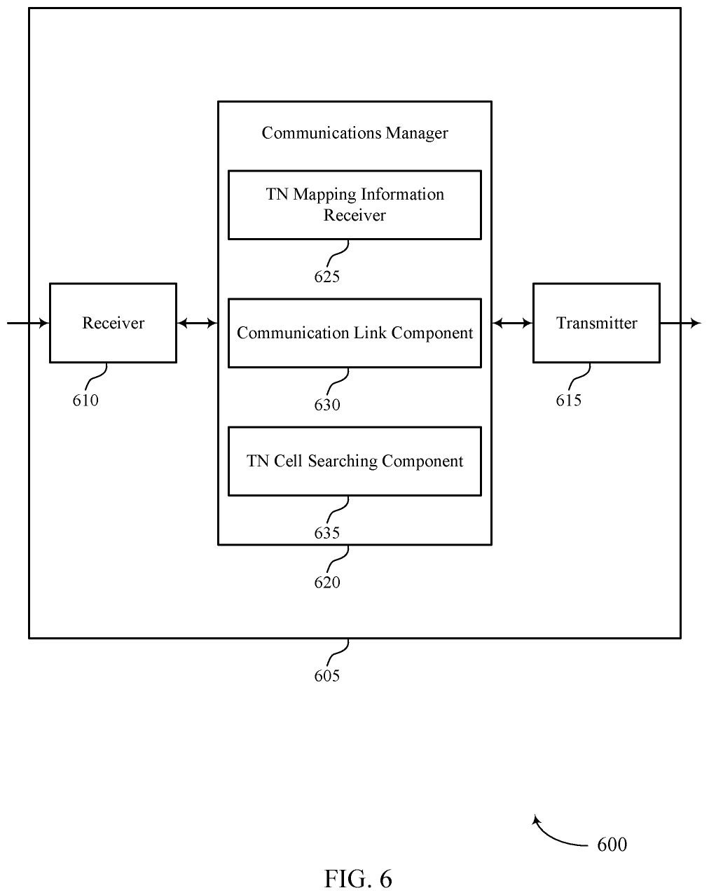

FIG. 6 shows a block diagram 600 of a device 605 that supports mobility enhancement for UEs connected to NTNs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to mobility enhancement for UEs connected to NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to mobility enhancement for UEs connected to NTNs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of mobility enhancement for UEs connected to NTNs as described herein. For example, the communications manager 620 may include a TN mapping information receiver 625, a communication link component 630, a TN cell searching component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The TN mapping information receiver 625 is capable of, configured to, or operable to support a means for receiving a message indicating TN mapping information, the TN mapping information associated with an ML model for estimating a signal quality map and coverage information for a set of multiple network entities, where each network entity of the set of multiple network entities is associated with a respective TN. The communication link component 630 is capable of, configured to, or operable to support a means for establishing a communication link between the UE and a first network entity that is associated with an NTN. The TN cell searching component 635 is capable of, configured to, or operable to support a means for searching, while connected to the first network entity, for one or more TN cells associated with at least a subset of network entities of the set of multiple network entities, where the searching is based on the signal quality map and the coverage information estimated via the ML model.

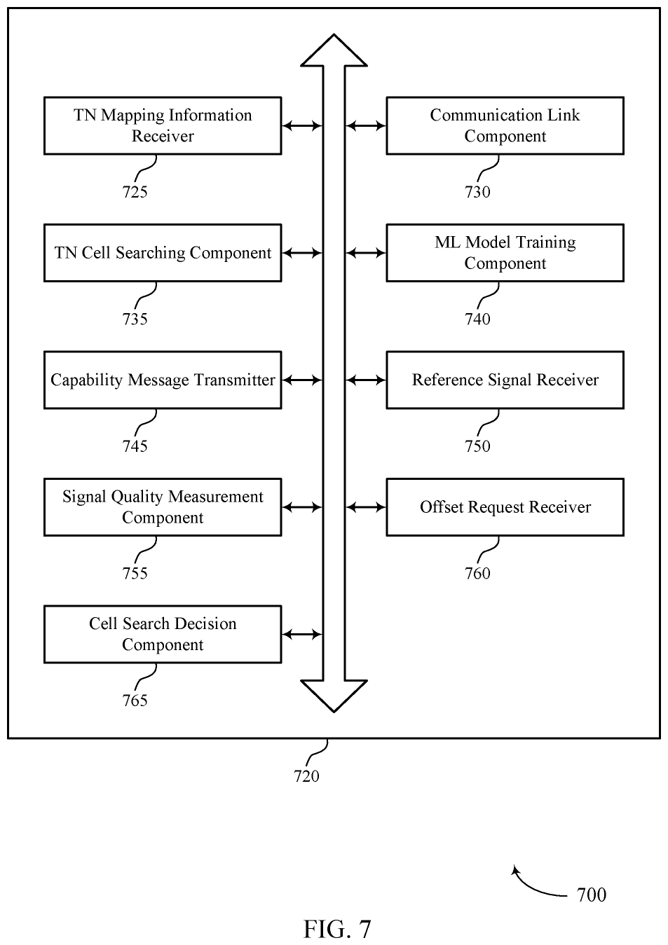

FIG. 7 shows a block diagram 700 of a communications manager 720 that supports mobility enhancement for UEs connected to NTNs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of mobility enhancement for UEs connected to NTNs as described herein. For example, the communications manager 720 may include a TN mapping information receiver 725, a communication link component 730, a TN cell searching component 735, an ML model training component 740, a capability message transmitter 745, a reference signal receiver 750, a signal quality measurement component 755, an offset request receiver 760, a cell search decision component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The TN mapping information receiver 725 is capable of, configured to, or operable to support a means for receiving a message indicating TN mapping information, the TN mapping information associated with an ML model for estimating a signal quality map and coverage information for a set of multiple network entities, where each network entity of the set of multiple network entities is associated with a respective TN. The communication link component 730 is capable of, configured to, or operable to support a means for establishing a communication link between the UE and a first network entity that is associated with an NTN. The TN cell searching component 735 is capable of, configured to, or operable to support a means for searching, while connected to the first network entity, for one or more TN cells associated with at least a subset of network entities of the set of multiple network entities, where the searching is based on the signal quality map and the coverage information estimated via the ML model.

In some examples, to support receiving the message indicating the TN mapping information, the TN mapping information receiver 725 is capable of, configured to, or operable to support a means for receiving the message indicating the ML model that is associated with the TN mapping information, the ML model being trained for generating the signal quality map and the coverage information for the one or more TN cells, where searching for the one or more TN cells is based on one or more outputs of the ML model.

In some examples, the ML model training component 740 is capable of, configured to, or operable to support a means for training the ML model using a set of training data at the UE, where the searching is based on one or more outputs of the ML model and in accordance with training the ML model.

In some examples, the ML model training component 740 is capable of, configured to, or operable to support a means for transmitting, to a network entity, a second message indicating the ML model for generating the signal quality map and the coverage information for the one or more TN cells.

In some examples, the ML model training component 740 is capable of, configured to, or operable to support a means for transmitting a capability message indicating that the UE is capable of transmitting the ML model, where transmitting the second message indicating the ML model in accordance with the capability message.

In some examples, the ML model training component 740 is capable of, configured to, or operable to support a means for transmitting, to a network entity, a second message indicating, per component carrier, one or more signal quality maps for the one or more TN cells, where the one or more signal quality maps are based on the ML model.

In some examples, the capability message transmitter 745 is capable of, configured to, or operable to support a means for transmitting a capability message indicating that the UE is capable of receiving the TN mapping information, where receiving the message indicating the TN mapping information is in accordance with the capability message.

In some examples, the reference signal receiver 750 is capable of, configured to, or operable to support a means for receiving a first set of reference signals from the set of multiple network entities associated with respective TNs. In some examples, the signal quality measurement component 755 is capable of, configured to, or operable to support a means for performing one or more signal quality measurements on a subset of reference signals from the first set of reference signals, where searching for the one or more TN cells is based on the one or more signal quality measurements including an input to the ML model.

In some examples, to support receiving the message indicating the TN mapping information, the TN mapping information receiver 725 is capable of, configured to, or operable to support a means for receiving the message indicating, for respective component carriers, one or more signal quality maps, where the ML model associated with the TN mapping information is associated with the one or more signal quality maps.

In some examples, the offset request receiver 760 is capable of, configured to, or operable to support a means for receiving, from a network entity of the set of multiple network entities that is associated with a respective TN, a request message indicating a request to apply an offset to a first component carrier for estimating coverage information for a second carrier component different from the first component carrier.

In some examples, the cell search decision component 765 is capable of, configured to, or operable to support a means for obtaining, via the ML model, a cell search decision for each TN cell associated with each network entity of the set of multiple network entities, where searching for the one or more TN cells is based on the cell search decision.

In some examples, the cell search decision includes a binary indication of whether to search for a respective TN cell. In some examples, searching for the one or more TN cells is based on the cell search decision satisfying a threshold search parameter. In some examples, the message indicating the TN mapping information is received from the first network entity or a second network entity from the set of multiple network entities that is associated with a respective TN.

In some examples, the coverage information for the set of multiple network entities includes coverage information for at least one network entity that is based on a NES mode of the at least one network entity, a TN configuration of the at least one network entity, or any combination thereof. In some examples, the TN mapping information includes one or more inputs for the ML model, the one or more inputs including positioning information of the set of multiple network entities, an indication of a configuration of each respective TN, an indication of a configuration of the NTN, or any combination thereof.

In some examples, the configuration of each respective TN, the configuration of the NTN, or both, include a transmission power, an indication of an energy savings mode, or both. In some examples, the ML model that is received by the UE is trained by a second UE. In some examples, the signal quality map includes a reference signal received power map, a reference signal received quality map, a signal interference noise ratio map, or any combination thereof.

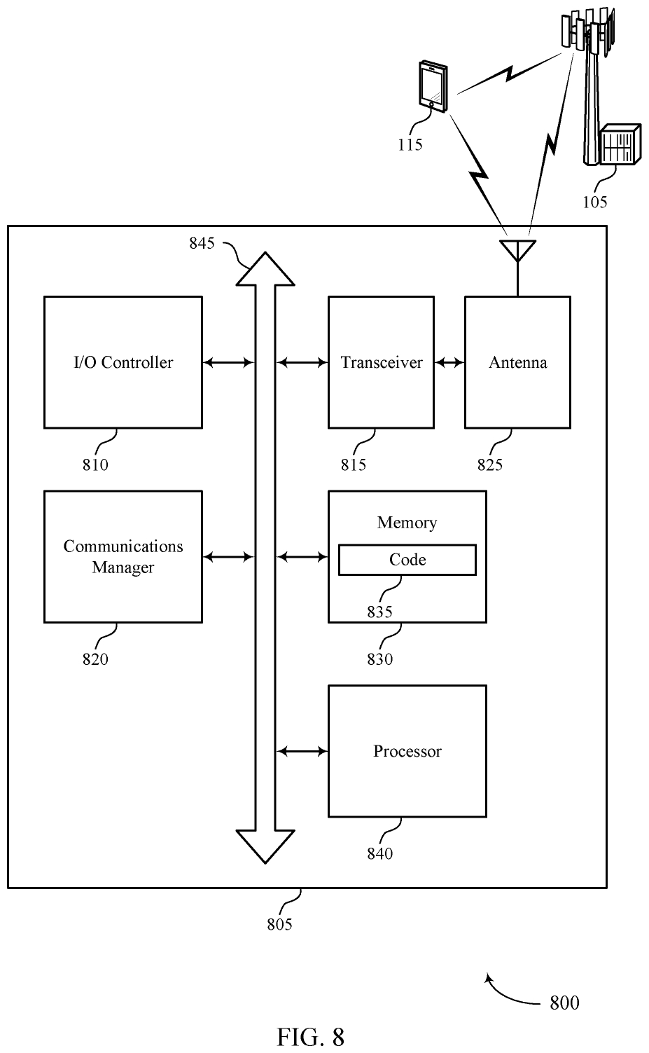

FIG. 8 shows a diagram of a system 800 including a device 805 that supports mobility enhancement for UEs connected to NTNs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting mobility enhancement for UEs connected to NTNs). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a message indicating TN mapping information, the TN mapping information associated with an ML model for estimating a signal quality map and coverage information for a set of multiple network entities, where each network entity of the set of multiple network entities is associated with a respective TN. The communications manager 820 is capable of, configured to, or operable to support a means for establishing a communication link between the UE and a first network entity that is associated with an NTN. The communications manager 820 is capable of, configured to, or operable to support a means for searching, while connected to the first network entity, for one or more TN cells associated with at least a subset of network entities of the set of multiple network entities, where the searching is based on the signal quality map and the coverage information estimated via the ML model.

By including or configuring the communications manager 820 in accordance with examples as described herein, the device 805 may support techniques for a UE to more accurately receive or determine TN coverage information to support improved communication reliability, reduced latency, improved user experience related to reduced processing, reduced power consumption, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of mobility enhancement for UEs connected to NTNs as described herein, or the at least one processor 840 and the at least one memory 830 may be otherwise configured to, individually or collectively, perform or support such operations.

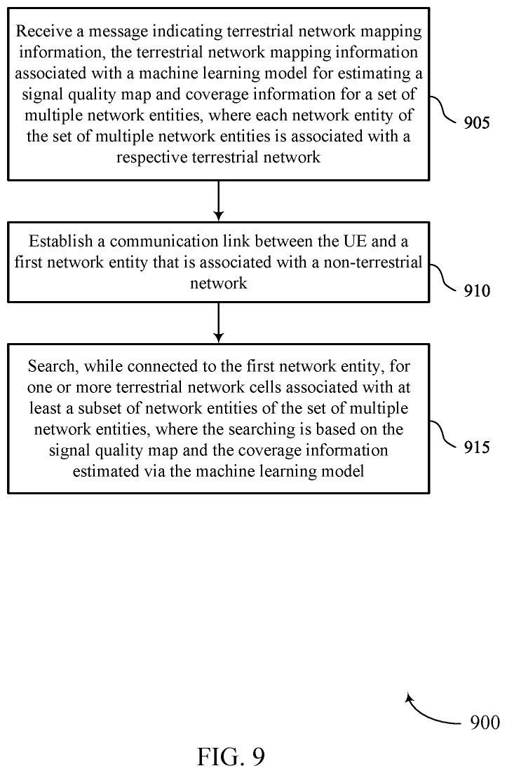

FIG. 9 shows a flowchart illustrating a method 900 that supports mobility enhancement for UEs connected to NTNs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a message indicating TN mapping information, the TN mapping information associated with an ML model for estimating a signal quality map and coverage information for a set of multiple network entities, where each network entity of the set of multiple network entities is associated with a respective TN. The operations of 905 may be performed in accordance with examples as disclosed herein. In some examples, aspects of the operations of 905 may be performed by a TN mapping information receiver 725 as described with reference to FIG. 7.

At 910, the method may include establishing a communication link between the UE and a first network entity that is associated with an NTN. The operations of 910 may be performed in accordance with examples as disclosed herein. In some examples, aspects of the operations of 910 may be performed by a communication link component 730 as described with reference to FIG. 7.

At 915, the method may include searching, while connected to the first network entity, for one or more TN cells associated with at least a subset of network entities of the set of multiple network entities, where the searching is based on the signal quality map and the coverage information estimated via the ML model. The operations of 915 may be performed in accordance with examples as disclosed herein. In some examples, aspects of the operations of 915 may be performed by a TN cell searching component 735 as described with reference to FIG. 7.

The following provides an overview of aspects of the present disclosure:

Aspect 1: A method for wireless communications by a UE, comprising: receiving a message indicating TN mapping information, the TN mapping information associated with a ML model for estimating a signal quality map and coverage information for a plurality of network entities, wherein each network entity of the plurality of network entities is associated with a respective TN; establishing a communication link between the UE and a first network entity that is associated with a NTN; and searching, while connected to the first network entity, for one or more TN cells associated with at least a subset of network entities of the plurality of network entities, wherein the searching is based at least in part on the signal quality map and the coverage information estimated via the ML model.

Aspect 2: The method of aspect 1, wherein receiving the message indicating the TN mapping information comprises: receiving the message indicating the ML model that is associated with the TN mapping information, the ML model being trained for generating the signal quality map and the coverage information for the one or more TN cells, wherein searching for the one or more TN cells is based at least in part on one or more outputs of the ML model.

Aspect 3: The method of any of aspects 1 through 2, further comprising: training the ML model using a set of training data at the UE, wherein the searching is based at least in part on one or more outputs of the ML model and in accordance with training the ML model.

Aspect 4: The method of aspect 3, further comprising: transmitting, to a network entity, a second message indicating the ML model for generating the signal quality map and the coverage information for the one or more TN cells.

Aspect 5: The method of aspect 4, further comprising: transmitting a capability message indicating that the UE is capable of transmitting the ML model, wherein transmitting the second message indicating the ML model in accordance with the capability message.

Aspect 6: The method of any of aspects 3 through 5, further comprising: transmitting, to a network entity, a second message indicating, per component carrier, one or more signal quality maps for the one or more TN cells, wherein the one or more signal quality maps are based at least in part on the ML model.

Aspect 7: The method of any of aspects 1 through 6, further comprising: transmitting a capability message indicating that the UE is capable of receiving the TN mapping information, wherein receiving the message indicating the TN mapping information is in accordance with the capability message.

Aspect 8: The method of any of aspects 1 through 7, further comprising: receiving a first set of reference signals from the plurality of network entities associated with respective TNs; and performing one or more signal quality measurements on a subset of reference signals from the first set of reference signals, wherein searching for the one or more TN cells is based at least in part on the one or more signal quality measurements comprising an input to the ML model.

Aspect 9: The method of any of aspects 1 through 8, wherein receiving the message indicating the TN mapping information comprises: receiving the message indicating, for respective component carriers, one or more signal quality maps, wherein the ML model associated with the TN mapping information is associated with the one or more signal quality maps.

Aspect 10: The method of any of aspects 1 through 9, further comprising: receiving, from a network entity of the plurality of network entities that is associated with a respective TN, a request message indicating a request to apply an offset to a first component carrier for estimating coverage information for a second carrier component different from the first component carrier.

Aspect 11: The method of any of aspects 1 through 10, further comprising: obtaining, via the ML model, a cell search decision for each TN cell associated with each network entity of the plurality of network entities, wherein searching for the one or more TN cells is based at least in part on the cell search decision.

Aspect 12: The method of aspect 11, wherein the cell search decision comprises a binary indication of whether to search for a respective TN cell.

Aspect 13: The method of any of aspects 11 through 12, wherein searching for the one or more TN cells is based at least in part on the cell search decision satisfying a threshold search parameter.

Aspect 14: The method of any of aspects 1 through 13, wherein the message indicating the TN mapping information is received from the first network entity or a second network entity from the plurality of network entities that is associated with a respective TN.

Aspect 15: The method of any of aspects 1 through 14, wherein the coverage information for the plurality of network entities comprises coverage information for at least one network entity that is based at least in part on a network energy savings mode of the at least one network entity, a TN configuration of the at least one network entity, or any combination thereof.

Aspect 16: The method of any of aspects 1 through 15, wherein the TN mapping information includes one or more inputs for the ML model, the one or more inputs comprising positioning information of the plurality of network entities, an indication of a configuration of each respective TN, an indication of a configuration of the NTN, or any combination thereof.

Aspect 17: The method of aspect 16, wherein the configuration of each respective TN, the configuration of the NTN, or both, comprise a transmission power, an indication of an energy savings mode, or both.

Aspect 18: The method of any of aspects 1 through 17, wherein the ML model that is received by the UE is trained by a second UE.

Aspect 19: The method of any of aspects 1 through 18, wherein the signal quality map comprises an RSRP map, an RSRQ map, a SINR map, or any combination thereof.

Aspect 20: A UE for wireless communications, comprising one or more memories storing processor-executable code, and one or more processors coupled with the one or more memories and individually or collectively operable to execute the code to cause the UE to perform a method of any of aspects 1 through 19.

Aspect 21: A UE for wireless communications, comprising at least one means for performing a method of any of aspects 1 through 19.

Aspect 22: A non-transitory computer-readable medium storing code for wireless communications, the code comprising instructions executable by one or more processors to perform a method of any of aspects 1 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a message indicating terrestrial network mapping information, the terrestrial network mapping information associated with a machine learning model for estimating a signal quality map and coverage information for a plurality of network entities, wherein each network entity of the plurality of network entities is associated with a respective terrestrial network;
establish a communication link between the UE and a first network entity that is associated with a non-terrestrial network; and
search, while connected to the first network entity, for one or more terrestrial network cells associated with at least a subset of network entities of the plurality of network entities, wherein the search is based at least in part on the signal quality map and the coverage information estimated via the machine learning model.

2. The UE of claim 1, wherein, to receive the message indicating the terrestrial network mapping information, the one or more processors are individually or collectively operable to execute the code to cause the UE to:
receive the message indicating the machine learning model that is associated with the terrestrial network mapping information, the machine learning model being trained for generating the signal quality map and the coverage information for the one or more terrestrial network cells, wherein searching for the one or more terrestrial network cells is based at least in part on one or more outputs of the machine learning model.

3. The UE of claim 1, wherein the one or more processors are individually or collectively further operable to execute the code to cause the UE to:
train the machine learning model using a set of training data at the UE, wherein the search is based at least in part on one or more outputs of the machine learning model and in accordance with training the machine learning model.

4. The UE of claim 3, wherein the one or more processors are individually or collectively further operable to execute the code to cause the UE to:
transmit, to a network entity, a second message indicating the machine learning model for generating the signal quality map and the coverage information for the one or more terrestrial network cells.

5. The UE of claim 4, wherein the one or more processors are individually or collectively further operable to execute the code to cause the UE to:
transmit a capability message indicating that the UE is capable of transmitting the machine learning model, wherein transmitting the second message indicating the machine learning model in accordance with the capability message.

6. The UE of claim 3, wherein the one or more processors are individually or collectively further operable to execute the code to cause the UE to:
transmit, to a network entity, a second message indicating, per component carrier, one or more signal quality maps for the one or more terrestrial network cells, wherein the one or more signal quality maps are based at least in part on the machine learning model.

7. The UE of claim 1, wherein the one or more processors are individually or collectively further operable to execute the code to cause the UE to:
transmit a capability message indicating that the UE is capable of receiving the terrestrial network mapping information, wherein receiving the message indicating the terrestrial network mapping information is in accordance with the capability message.

8. The UE of claim 1, wherein the one or more processors are individually or collectively further operable to execute the code to cause the UE to:
receive a first set of reference signals from the plurality of network entities associated with respective terrestrial networks; and
perform one or more signal quality measurements on a subset of reference signals from the first set of reference signals, wherein searching for the one or more terrestrial network cells is based at least in part on the one or more signal quality measurements comprising an input to the machine learning model.

9. The UE of claim 1, wherein, to receive the message indicating the terrestrial network mapping information, the one or more processors are individually or collectively operable to execute the code to cause the UE to:
receive the message indicating, for respective component carriers, one or more signal quality maps, wherein the machine learning model associated with the terrestrial network mapping information is associated with the one or more signal quality maps.

10. The UE of claim 1, wherein the one or more processors are individually or collectively further operable to execute the code to cause the UE to:
receive, from a network entity of the plurality of network entities that is associated with a terrestrial network, a request message indicating a request to apply an offset to a first component carrier for estimating coverage information for a second carrier component different from the first component carrier.

11. The UE of claim 1, wherein the one or more processors are individually or collectively further operable to execute the code to cause the UE to:
obtain, via the machine learning model, a cell search decision for each terrestrial network cell associated with each network entity of the plurality of network entities, wherein searching for the one or more terrestrial network cells is based at least in part on the cell search decision.

12. The UE of claim 11, wherein the cell search decision comprises a binary indication of whether to search for a respective terrestrial network cell.

13. The UE of claim 11, wherein searching for the one or more terrestrial network cells is based at least in part on the cell search decision satisfying a threshold search parameter.

14. The UE of claim 1, wherein the message indicating the terrestrial network mapping information is received from the first network entity or a second network entity from the plurality of network entities that is associated with a terrestrial network.

15. The UE of claim 1, wherein the coverage information for the plurality of network entities comprises coverage information for at least one network entity that is based at least in part on a network energy savings mode of the at least one network entity, a terrestrial network configuration of the at least one network entity, or any combination thereof.

16. The UE of claim 1, wherein the terrestrial network mapping information includes one or more inputs for the machine learning model, the one or more inputs comprising positioning information of the plurality of network entities, an indication of a configuration of each respective terrestrial network, an indication of a configuration of the non-terrestrial network, or any combination thereof.

17. The UE of claim 16, wherein the configuration of each respective terrestrial network, the configuration of the non-terrestrial network, or both, comprise a transmission power, an indication of an energy savings mode, or both.

18. The UE of claim 1, wherein the machine learning model that is received by the UE is trained by a second UE.

19. The UE of claim 1, wherein the signal quality map comprises a reference signal received power map, a reference signal received quality map, a signal interference noise ratio map, or any combination thereof.

20. A method for wireless communications by a user equipment (UE), comprising:
receiving a message indicating terrestrial network mapping information, the terrestrial network mapping information associated with a machine learning model for estimating a signal quality map and coverage information for a plurality of network entities, wherein each network entity of the plurality of network entities is associated with a respective terrestrial network;
establishing a communication link between the UE and a first network entity that is associated with a non-terrestrial network; and
searching, while connected to the first network entity, for one or more terrestrial network cells associated with at least a subset of network entities of the plurality of network entities, wherein the searching is based at least in part on the signal quality map and the coverage information estimated via the machine learning model.

21. The method of claim 20, wherein receiving the message indicating the terrestrial network mapping information comprises:
receiving the message indicating the machine learning model that is associated with the terrestrial network mapping information, the machine learning model being trained for generating the signal quality map and the coverage information for the one or more terrestrial network cells, wherein searching for the one or more terrestrial network cells is based at least in part on one or more outputs of the machine learning model.

22. The method of claim 20, further comprising:
training the machine learning model using a set of training data at the UE, wherein the searching is based at least in part on one or more outputs of the machine learning model and in accordance with training the machine learning model.

23. The method of claim 22, further comprising:
transmitting, to a network entity, a second message indicating the machine learning model for generating the signal quality map and the coverage information for the one or more terrestrial network cells.

24. The method of claim 22, further comprising:
transmitting, to a network entity, a second message indicating, per component carrier, one or more signal quality maps for the one or more terrestrial network cells, wherein the one or more signal quality maps are based at least in part on the machine learning model.

25. The method of claim 20, further comprising:
transmitting a capability message indicating that the UE is capable of receiving the terrestrial network mapping information, wherein receiving the message indicating the terrestrial network mapping information is in accordance with the capability message.

26. The method of claim 20, further comprising:
receiving a first set of reference signals from the plurality of network entities associated with respective terrestrial networks; and
performing one or more signal quality measurements on a subset of reference signals from the first set of reference signals, wherein searching for the one or more terrestrial network cells is based at least in part on the one or more signal quality measurements comprising an input to the machine learning model.

27. The method of claim 20, wherein receiving the message indicating the terrestrial network mapping information comprises:
receiving the message indicating, for respective component carriers, one or more signal quality maps, wherein the machine learning model associated with the terrestrial network mapping information is associated with the one or more signal quality maps.

28. The method of claim 20, further comprising:
obtaining, via the machine learning model, a cell search decision for each terrestrial network cell associated with each network entity of the plurality of network entities, wherein searching for the one or more terrestrial network cells is based at least in part on the cell search decision.

29. A user equipment (UE) for wireless communications, comprising:
means for receiving a message indicating terrestrial network mapping information, the terrestrial network mapping information associated with a machine learning model for estimating a signal quality map and coverage information for a plurality of network entities, wherein each network entity of the plurality of network entities is associated with a respective terrestrial network;
means for establishing a communication link between the UE and a first network entity that is associated with a non-terrestrial network; and
means for searching, while connected to the first network entity, for one or more terrestrial network cells associated with at least a subset of network entities of the plurality of network entities, wherein the searching is based at least in part on the signal quality map and the coverage information estimated via the machine learning model.

30. A non-transitory computer-readable medium storing code for wireless communications, the code comprising instructions executable by one or more processors to:
receive a message indicating terrestrial network mapping information, the terrestrial network mapping information associated with a machine learning model for estimating a signal quality map and coverage information for a plurality of network entities, wherein each network entity of the plurality of network entities is associated with a respective terrestrial network;
establish a communication link between a user equipment (UE) and a first network entity that is associated with a non-terrestrial network; and
search, while connected to the first network entity, for one or more terrestrial network cells associated with at least a subset of network entities of the plurality of network entities, wherein the search is based at least in part on the signal quality map and the coverage information estimated via the machine learning model.
